(19) United States
(12) Patent Application Publication
(10) Pub. No.: US 2021/0279509 A1
(43) Pub. Date: Sep. 9, 2021

(54) Method and System For Processing Images Using Cross-Stage Skip Connections

(71) Applicant: GUANGDONG OPPO MOBILE TELECOMMUNICATIONS CORP., LTD., Dongguan (CN)

(72) Inventors: Zibo Meng, Palo Alto, CA (US); Ming Chen, Palo Alto, CA (US)

(21) Appl. No.: 17/319,597

(22) Filed: May 13, 2021

Related U.S. Application Data
(63) Continuation of application No. PCT/CN2019/105464, filed on Sep. 11, 2019.
(60) Provisional application No. 62/767,942, filed on Nov. 15, 2018.

(51) Int. Cl. G06K 9/62; G06T 3/40; G06N 3/04

(52) U.S. Cl. CPC G06K 9/6232; G06K 9/40; G06N 3/0454; G06T 3/40

(57) ABSTRACT

In an embodiment, a computer-implemented method includes receiving and processing a first image, and outputting a first feature map by an encoder. The encoder includes a plurality of first convolutional stages that receive the first image and output stage-by-stage a plurality of second feature maps corresponding to the first convolutional stages. The second feature maps have gradually decreased scales. For each second convolutional stage of the first convolutional stages, a first skip connection is added between each second convolutional stage and each of at least one remaining convolutional stage of the first convolutional stages corresponding to each second convolutional stage.

### CROSS-REFERENCE TO RELATED APPLICATION(S)

This application is a continuation-application of International (PCT) Patent Application No. PCT/CN2019/105464 filed on Sep. 11, 2019, which claims priority to a U.S. application No. 62/767,942 filed on Nov. 15, 2018, the entire contents of both of which are hereby incorporated by reference.

### TECHNICAL FIELD

The present disclosure relates to the field of image processing, and more particularly, to and a method and a system for processing images using cross-stage skip connections.

### BACKGROUND

When images are captured under, for example, low-light conditions or underwater conditions, it may be hard to identify content of the image due to a low signal-to-noise ratio (SNR), low contrast, and/or a narrow dynamic range. Image denoising techniques remove image noise. Image enhancement techniques improve perceptual qualities such as contrast of images. Image denoising techniques and/or image enhancement techniques aim at providing images with saturated colors and fruitful details albeit being taking under, for example, low-light conditions or underwater conditions.

### SUMMARY

In a first aspect of the present disclosure, a computer-implemented method includes receiving and processing a first image, and outputting a first feature map by an encoder. The encoder includes a plurality of first convolutional stages that receive the first image and output stage-by-stage a plurality of second feature maps corresponding to the first convolutional stages. The second feature maps have gradually decreased scales. For each second convolutional stage of the first convolutional stages, a first skip connection is added between each second convolutional stage and each of at least one remaining convolutional stage of the first convolutional stages corresponding to each second convolutional stage.

In a second aspect of the present disclosure, a system includes at least one memory and at least one processor. The at least one memory is configured to store program instructions. The at least one processor is configured to execute the program instructions, which cause the at least one processor to perform steps including receiving and processing a first image, and outputting a first feature map by an encoder. The encoder includes a plurality of first convolutional stages that receive the first image and output stage-by-stage a plurality of second feature maps corresponding to the first convolutional stages. The second feature maps have gradually decreased scales. For each second convolutional stage of the first convolutional stages, a first skip connection is added between each second convolutional stage and each of at least one remaining convolutional stage of the first convolutional stages corresponding to each second convolutional stage.

In a third aspect of the present disclosure, a system includes at least one memory and at least one processor. The at least one memory is configured to store program instructions. The at least one processor is configured to execute the program instructions, which cause the at least one processor to perform steps including receiving and processing a first feature map, and outputting a first image by a decoder. The first feature map is output by an encoder, and the decoder includes a plurality of first convolutional stages that receive the first feature map and output stage-by-stage a plurality of second feature maps corresponding to the first convolutional stages. The first feature map and the second feature maps have gradually increased scales. For each second convolutional stage of the last convolutional stage of the encoder and the first convolutional stages, a first skip connection is added between each second convolutional stage and each of at least one remaining convolutional stage of the first convolutional stages corresponding to each second convolutional stage. The last convolutional stage of the encoder outputs the first feature map. Each second convolutional stage outputs a corresponding third feature map of which a scale is increased in a corresponding third convolutional stage of the first convolutional stages. The corresponding third convolutional stage is immediately subsequent to each second convolutional stage.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram illustrating inputting, processing, and outputting hardware modules in a terminal in accordance with an embodiment of the present disclosure.

FIG. 2 is a diagram illustrating an encoder-decoder network with cross-stage skip connections in accordance with an embodiment of the present disclosure.

FIG. 3 is a diagram illustrating cross-stage skip connections for an exemplary convolutional stage of an encoder of the encoder-decoder network in accordance with an embodiment of the present disclosure.

FIG. 4A is a diagram illustrating a downscaling stage of an exemplary cross-stage skip connection for the exemplary convolutional stage of the encoder in accordance with an embodiment of the present disclosure.

FIG. 4B is a diagram illustrating the downscaling stage of the exemplary cross-stage skip connection for the exemplary convolutional stage of the encoder in accordance with another embodiment of the present disclosure.

FIG. 5 is diagram illustrating cross-stage skip connections for an exemplary convolutional stage of a decoder of the encoder-decoder network in accordance with an embodiment of the present disclosure.

FIG. 6A is a diagram illustrating an upscaling stage of an exemplary cross-stage skip connection for the exemplary convolutional stage of the decoder in accordance with an embodiment of the present disclosure.

FIG. 6B is a diagram illustrating the upscaling stage of the exemplary cross-stage skip connection for the exemplary convolutional stage of the decoder in accordance with another embodiment of the present disclosure.

FIG. 7 is a diagram illustrating an encoder-decoder network with cross-stage skip connections in accordance with another embodiment of the present disclosure.

FIG. 8 is a diagram illustrating an encoder-decoder network with cross-stage skip connections in accordance with still another embodiment of the present disclosure.

### DETAILED DESCRIPTION

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the invention.

As used here, the term “using” refers to a case in which an object is directly employed for performing a step, or a case in which the object is modified by at least one intervening step and the modified object is directly employed to perform the step.

According to a first aspect, a computer-implemented method is provided and includes receiving and processing a first image, and outputting a first feature map by an encoder. The encoder includes: a plurality of first convolutional stages that receive the first image and output stage-by-stage a plurality of second feature maps corresponding to the first convolutional stages. The second feature maps have gradually decreased scales. For each second convolutional stage of the first convolutional stages, a first skip connection is added between each second convolutional stage and each of at least one remaining convolutional stage of the first convolutional stages corresponding to each second convolutional stage.

In some embodiments, the first skip connection includes downscaling one of the second feature maps, to generate a third feature map, and adding the third feature map in addition, to obtain a sum Xⱼ of fourth feature maps by following an equation:

Xⱼ=Σᵢ₌ₐ^{i=j}Fᵢⱼ

Wherein a is a stage number of the first of the first convolutional stages, i is a stage number of a first source stage in the first convolutional stages, j is a stage number of a first destination stage of the first convolutional stages, and when i<j, Fᵢⱼ is the third feature map obtained by the first skip connection between the first source stage with the stage number i, and the first destination stage with the stage number j, and when i=j, Fᵢⱼ is a fifth feature map obtained by the first destination stage with the stage number. A scale of the third feature map is same as a scale of the fifth feature map.

In some embodiments, downscaling is performed by a first downscaling stage including a first activation function that outputs the third feature map; the first destination stage with the stage number j comprises a first convolutional layer and a second activation function; the first convolutional layer outputs the fifth feature map, and the second activation function receives the sum of the fourth feature maps and outputs a sixth feature map of the second feature maps.

In some embodiments, the first downscaling stage further comprises a second convolutional layer preceding the first activation function and having a first stride such that the second convolutional layer decreases the scale of the one of the second feature maps to the scale of the third feature map.

In some embodiments, the second convolutional layer is a 1×1 convolutional layer.

In some embodiments, the first downscaling stage further comprises a first pooling layer that decreases the scale of the one of the second feature maps to the scale of the third feature map, and a third convolutional layer following the first pooling layer and having a stride of 1.

In some embodiments, the third convolutional layer is a 1×1 convolutional layer.

In some embodiments, a number of channels of the fifth feature map is set such that the fifth feature map does not have information which is redundant with respect to the third feature map.

In some embodiments, the last of the second feature maps is the first feature map.

In some embodiments, the encoder further includes a bottleneck stage that receives the last of the second feature maps and outputs the first feature map, wherein the bottleneck stage comprises a global pooling layer.

In some embodiments, the method further includes: receiving and processing the first feature map, and outputting a second image by a decoder. The decoder includes: a plurality of third convolutional stages that receive the first feature map and output stage-by-stage a plurality of seventh feature maps corresponding to the third convolutional stages. The first feature map and the seventh feature maps have gradually increased scales. For each fourth convolutional stage of the last convolutional stage of the encoder and the third convolutional stages, a second skip connection is added between each fourth convolutional stage and each of at least one remaining convolutional stage of the third convolutional stages corresponding to each fourth convolutional stage. The last convolutional stage of the encoder outputs the first feature map. Each fourth convolutional stage outputs a corresponding eighth feature map of which a scale is increased in a corresponding fifth convolutional stage of the third convolutional stages, wherein the corresponding fifth convolutional stage is immediately subsequent to each fourth convolutional stage.

In some embodiments, the second skip connection comprises upscaling one of the first feature map and the seventh feature maps, to generate a ninth feature map, and adding the ninth feature map in addition, to obtain a sum Xₙ of tenth feature maps by following an equation:

Xⱼ=Σᵢ₌ₐ^{i=j}Fᵢⱼ

Wherein b is a stage number of the last convolutional stage of the encoder, m is a stage number of a second source stage which is one of the last convolutional stage of the encoder and the third convolutional stages, n is a stage number of a second destination stage of the third convolutional stages, and when m<n, Fₘₙ is the ninth feature map obtained by the second skip connection between the second source stage with the stage number m and the second destination stage with the stage number n, and when m=n, Fₘₙ is an eleventh feature map obtained by the second destination stage with the stage number n. A scale of the ninth feature map is same as a scale of the eleventh feature map.

In some embodiments, upscaling is performed by a first upscaling stage comprising a third activation function that outputs the ninth feature map; the second destination stage with the stage number n comprises a fourth convolutional layer and a fourth activation function; the fourth convolutional layer outputs the eleventh feature map, and the fourth activation function receives the sum of the tenth feature maps and outputs a twelfth feature map of the seventh feature maps.

In some embodiments, the first upscaling stage further includes a first deconvolutional layer preceding the third activation function and having a second stride such that the first deconvolutional layer increases the scale of the one of the first feature map and the seventh feature maps to the scale of the ninth feature map.

In some embodiments, the first deconvolutional layer is a 1×1 deconvolutional layer.

In some embodiments, the first upscaling stage further comprises a first upsampling layer that increases the scale of the one of the first feature map and the seventh feature maps to the scale of the ninth feature map, and a fifth convolutional layer following the first upsampling layer and having a stride of 1.

In some embodiments, the fifth convolutional layer is a 1×1 convolutional layer.

In some embodiments, a number of channels of the eleventh feature map is set such that the eleventh feature map does not have information which is redundant with respect to the ninth feature map.

According to a second aspect, a system is provided and includes at least one memory configured to store program instructions; and at least one processor configured to execute the program instructions, which cause the at least one processor to perform steps including: receiving and processing a first image, and outputting a first feature map by an encoder. The encoder includes a plurality of first convolutional stages that receive the first image and output stage-by-stage a plurality of second feature maps corresponding to the first convolutional stages. The second feature maps have gradually decreased scales. For each second convolutional stage of the first convolutional stages, a first skip connection is added between each second convolutional stage and each of at least one remaining convolutional stage of the first convolutional stages corresponding to each second convolutional stage.

According to a third aspect, a system is provided and includes: at least one memory configured to store program instructions; and at least one processor configured to execute the program instructions, which cause the at least one processor to perform steps including: receiving and processing a first feature map, and outputting a first image by a decoder. The decoder includes: a plurality of first convolutional stages that receive the first feature map and output stage-by-stage a plurality of second feature maps corresponding to the first convolutional stages. The first feature map and the second feature maps have gradually increased scales. For each second convolutional stage of the last convolutional stage of the encoder and the first convolutional stages, a first skip connection is added between each second convolutional stage and each of at least one remaining convolutional stage of the first convolutional stages corresponding to each second convolutional stage. The last convolutional stage of the encoder outputs the first feature map. Each second convolutional stage outputs a corresponding third feature map of which a scale is increased in a corresponding third convolutional stage of the first convolutional stages, wherein the corresponding third convolutional stage is immediately subsequent to each second convolutional stage.

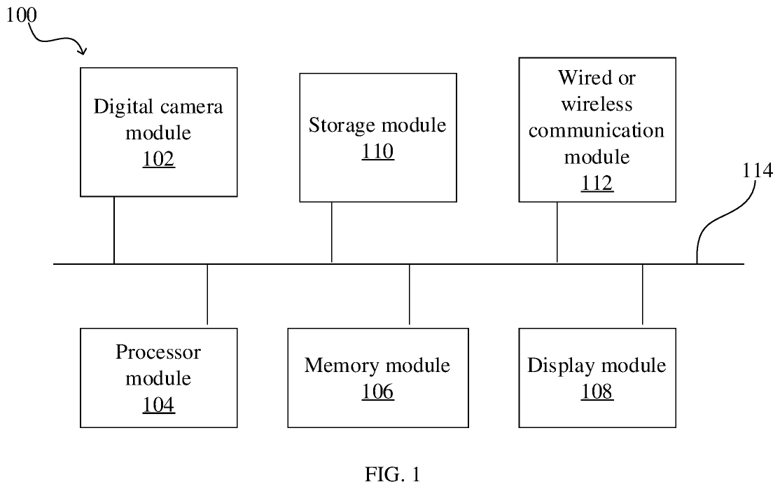

FIG. 1 is a block diagram illustrating inputting, processing, and outputting hardware modules in a terminal 100 in accordance with an embodiment of the present disclosure. Referring to FIG. 1, the terminal 100 includes a digital camera module 102, a processor module 104, a memory module 106, a display module 108, a storage module 110, a wired or wireless communication module 112, and buses 114. The terminal 100 may be cell phones, smartphones, tablets, notebook computers, desktop computers, or any electronic device having enough computing power to perform image processing.

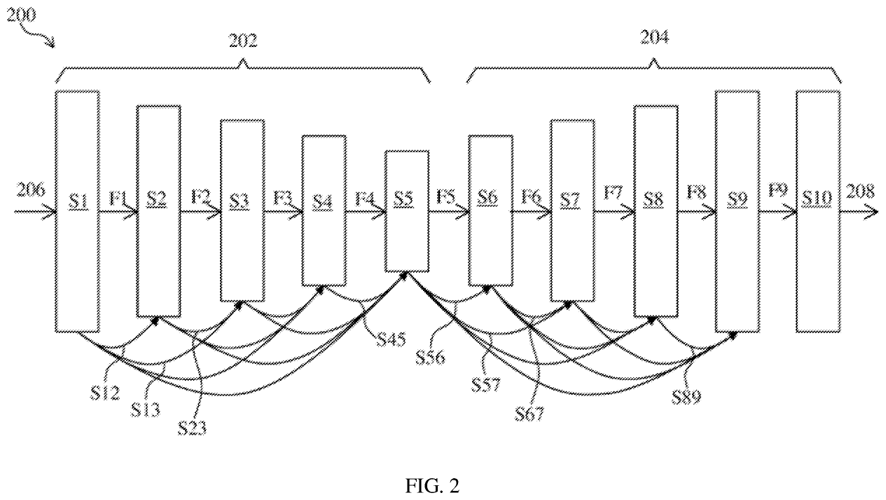

The digital camera module 102 is an inputting hardware module and is configured to capture an input image 206 (labeled in FIG. 2) that is to be transmitted to the processor module 104 through the buses 114. The input image 206 may be a raw image with pixels arranged in a Bayer pattern. Alternatively, the input image 206 may be obtained using another inputting hardware module, such as the storage module 110, or the wired or wireless communication module 112. The storage module 110 is configured to store an input image 206 that is to be transmitted to the processor module 104 through the buses 114. The wired or wireless communication module 112 is configured to receive an input image 206 from a network through wired or wireless communication, wherein the input image 206 is to be transmitted to the processor module 104 through the buses 114.

When the input image is captured, for example, under a low-light condition or an underwater condition, or with an insufficient amount of exposure time, it may be hard to identify content of the input image due to a low signal-to-noise ratio (SNR), low contrast, and/or a narrow dynamic range. The memory module 106 may be a transitory or non-transitory computer-readable medium that includes at least one memory storing program instructions that, when executed by the processor module 104, cause the processor module 104 to process the input image. The processor module 104 implements an encoder-decoder network 200 (shown in FIG. 2) that performs image denoising and/or enhancement on the input image 206 and generate an output image 208 (labeled in FIG. 2). The processor module 104 includes at least one processor that sends signals directly or indirectly to and/or receives signals directly or indirectly from the digital camera module 102, the memory module 106, the display module 108, the storage module 110, and the wired or wireless communication module 112 via the buses 114. The at least one processor may be central processing unit(s) (CPU(s)), graphics processing unit(s) (GPU(s)), and/or digital signal processor(s) (DSP(s)). The CPU(s) may send the input image 206, some of the program instructions and other data or instructions to the GPU(s), and/or DSP(s) via the buses 114.

The display module 108 is an outputting hardware module and is configured to display the output image 208 that is received from the processor module 104 through the buses 114. Alternatively, the output image 208 may be output using another outputting hardware module, such as the storage module 110, or the wired or wireless communication module 112. The storage module 110 is configured to store the output image 208 that is received from the processor module 104 through the buses 114. The wired or wireless communication module 112 is configured to transmit the output image 208 to the network through wired or wireless communication, wherein the output image 208 is received from the processor module 104 through the buses 114.

The terminal 100 is one type of computing system all of components of which are integrated together by the buses 114. Other types of computing systems such as a computing system that has a remote digital camera module instead of the digital camera module 102 are within the contemplated scope of the present disclosure.

FIG. 2 is a diagram illustrating an encoder-decoder network 200 with cross-stage skip connections S12 to S45, and S56 to S89 in accordance with an embodiment of the present disclosure. Given an input image I, the encoder-decoder network 200 learns a mapping I′=f(I:w) that renders the input image I denoised and/or enhanced, to generate an output image I′, where w is a set of learnable parameters of the encoder-decoder network 200. The encoder-decoder network 200 with learned parameters performs image denoising and/or enhancement on the input image 206, to generate the output image 208. In an embodiment, the output image 208 is an RGB image.

In an embodiment, the encoder-decoder network 200 has a U-net architecture. Examples of the U-net architecture are described in more detail in “U-net: Convolutional networks for biomedical image segmentation,” O. Ronneberger, P. Fischer, and T. Brox, arXiv preprint arXiv: 1505.04597 [cs.CV], 2015. The encoder-decoder network 200 includes an encoder 202 and a decoder 204. The encoder 202 is configured to receive the input image 206, extract features of the input image 206, and output a feature map F5. The decoder 204 is configured to receive the feature map F5, reconstruct from the feature map F5, and output the output image 208. The encoder 202 includes a plurality of convolutional stages S1 to S5. The decoder 204 includes a plurality of convolutional stages S6 to S10. The convolutional stages S1 to S5 receive the input image 206, and output stage-by-stage a plurality of feature maps F1 to F5 corresponding to the convolutional stages S1 to S5. The convolutional stages S6 to S9 receive the feature map F5, and output stage-by-stage a plurality of feature maps F6 to F9 corresponding to the convolutional stages S6 to S9. The convolutional stage S10 receives the feature map F9 and outputs the output image 208. In an embodiment, the convolutional stage S10 includes a 1×1 vanilla convolutional layer that receives the feature map F9 and outputs the output image 208.

The feature maps F1 to F9 are multi-channel feature maps. For the encoder 202, the feature maps F1 to F5 have gradually decreased scales (i.e. spatial resolutions), which is represented by decreasing sizes of rectangles corresponding to the convolutional stages S1 to S5. The feature maps F1 to F5 have gradually increased number of channels. For the decoder 204, the feature maps F5 to F9 have gradually increased scales, which is represented by increasing sizes of rectangles corresponding to the convolutional stages S5 to S9. The feature maps F5 to F9 have gradually decreased number of channels.

Cross-stage skip connections S12 to S45 are added for the convolutional stages S1 to S5. For each convolutional stage S1, . . . , or S4 of the convolutional stages S1 to S5, the skip connection S12, . . . , or S45 is added between each convolutional stage S1, . . . , or S4 and each of at least one remaining convolutional stage S2 to S5, . . . , or S5 of the convolutional stages S1 to S5 corresponding to each convolutional stage S1, . . . , or S4. Cross-stage skip connections S56 to S89 are added for the convolutional stage S5 of the encoder 202, and the convolutional stages S6 to S9 of the decoder 204. For each convolutional stage S5, . . . , or S8 of the last convolutional stage S5 of the encoder 202 and the convolutional stages S6 to S9 of the decoder 204, the skip connection S56, . . . , or S89 is added between each convolutional stage S5, . . . , or S8 and each of at least one remaining convolutional stage S6 to S9, . . . , or S9 of the convolutional stages S6 to S9 corresponding to each convolutional stage S5, . . . , or S8. The last convolutional stage S5 of the encoder 202 outputs the feature map F5. Each convolutional stage S5, . . . , or S8 of the last convolutional stage S5 of the encoder 202 and the convolutional stages S6 to S9 of the decoder 204 outputs a corresponding feature map F5, . . . , or F8 of which a scale is increased in a corresponding convolutional stage S6, . . . , or S9 of the convolutional stages S6 to S9, and the corresponding convolutional stage S6, . . . , or S9 is immediately subsequent to each convolutional stage S5, . . . , or S8.

The first number of a reference numeral of a skip connection is a stage number of a source stage. The second number of a reference numeral of the skip connection is a stage number of a destination stage. For example, the first number “1” of a reference numeral “S12” of the skip connection S12 is a stage number “1” of the source stage S1, and the second number “2” of the reference numeral “S12” of the skip connection S12 is a stage number “2” of the destination stage. For simplicity, the skip connections in FIG. 2 are exemplarily labeled.

The term “at least one remaining convolutional stage corresponding to a first convolutional stage” refers that in a group of convolutional stages, the at least one remaining convolutional stage corresponding to the first convolutional stage is all of at least one convolutional stage that is immediately subsequent to the first convolutional stage.

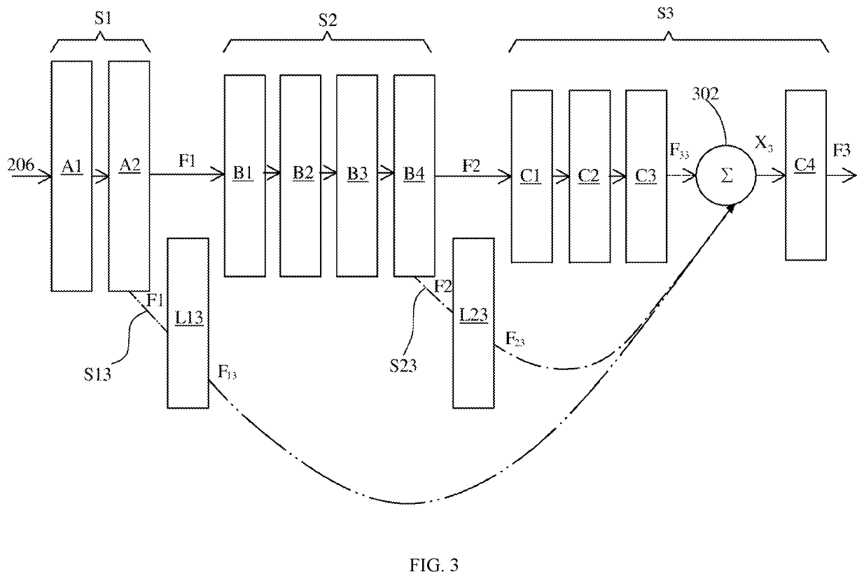

FIG. 3 is a diagram illustrating the skip connections S13 and S23 for the exemplary convolutional stage S3 of the encoder 202 (show in FIG. 2) in accordance with an embodiment of the present disclosure. The convolutional stage S1 includes a convolutional layer A1 with a first activation function, and a convolutional layer A2 with the first activation function. The convolutional layer A1 receives the input image 206, the convolutional layers A1 and A2 process layer-by-layer, and the convolutional layer A2 outputs the feature map F1. In an embodiment, the convolutional layers A1 and A2 are 3×3 convolutional layers. In an embodiment, the first activation function is a nonlinear activation function such as a Leaky ReLU operation.

The convolutional stage S2 includes a downscaling layer B1, a convolutional layer B2 with the first activation function, a convolutional layer B3 without the first activation function, and an activation function B4. The downscaling layer B1 receives the feature map F1, the downscaling layer B1, the convolutional layers B2 and B3, and the activation function B4 process layer-by-layer, and the activation function B4 outputs the feature map F2. The downscaling layer B1 downscales the feature map F1 with a downscaling factor such as 2. In an embodiment, the downscaling layer B1 is a pooling layer such as a max pooling layer or an average pooling layer. Other downscaling layers such as a convolutional layer with a stride of 2 are within the contemplated scope of the present disclosure. In an embodiment, the convolutional layers B2 and B3 are 3×3 convolutional layers. In an embodiment, the activation function B4 is a nonlinear activation function such as a Leaky ReLU operation.

The convolutional stage S3 includes a downscaling layer C1, a convolutional layer C2 with the first activation function, a convolutional layer C3 without the first activation function, a summation block 302, and an activation function C4. The downscaling layer C1 receives the feature map F2, the downscaling layer C1, the convolutional layers C2 and C3, and the activation function C4 process layer-by-layer, and the activation function C4 outputs the feature map F3. The downscaling layer C1 downscales the feature map F2 with a downscaling factor such as 2. In an embodiment, the downscaling layer C1 is a pooling layer such as a max pooling layer or an average pooling layer. Other downscaling layers such as a convolutional layer with a stride of 2 are within the contemplated scope of the present disclosure. In an embodiment, the convolutional layers C2 and C3 are 3×3 convolutional layers. In an embodiment, the activation function C4 is a nonlinear activation function such as a Leaky ReLU operation.

The skip connection S13 or S23 includes downscaling the feature map F1 or F2 of the feature maps F1 to F5 (shown in FIG. 2) by a downscaling stage L13 or L23, to generate a feature map F₁₃ or F₂₃, and adding the feature map F₁₃ or F₂₃ in addition by the summation block 302, to obtain a sum Xᵢ of feature maps by following equation (1):

Xⱼ=Σᵢ₌ₐ^{i=j}Fᵢⱼ (1)

, where a is a stage number “1” of the first of the convolutional stages S1 to S5, i is a stage number “1” or “2” of a source stage S1 or S2 in the convolutional stages S1 to S5, j is a stage number “3” of a destination stage S3 of the convolutional stages S1 to S5, and when i<j, Fᵢⱼ is the feature map F₁₃ or F₂₃ obtained by the skip connection S13 or S23 between the source stage S1 or S2 with the stage number i, and the destination stage S3 with the stage number j, and when i=j, Fᵢⱼ is a feature map F₃₃ obtained by the destination stage S3 with the stage number j. A scale and a number of channels of each of the feature maps F₁₃ and F₂₃, is same as a scale and a number of channels of the feature map F₃₃. In an embodiment, because the downscaling layer B1 and the downscaling layer C1 has the downscaling factor of 2, the downscaling stage L13 has a downscaling factor of 4, and the downscaling stage L23 has a downscaling factor of 2. Each summation operation (i.e. adding operation) in equation (1) is an element-wise summation operation.

In an embodiment, a number of channels of the feature map F₃₃ is set such that the feature map F₃₃ does not have information which is redundant with respect to the feature map F₁₃ or F₂₃. In this way, the convolutional stage S3 does not need to learn and generate information that has been learned and generated by the convolutional stages S1 and S2. The reuse of the feature map F₁₃ or F₂₃ instead of having redundant information respect to the feature map F₁₃ or F₂₃ in the feature map F₃₃ is represented by 3 dashed lines with different dashed line styles corresponding to the feature maps F₁₃, F₂₃, and F₃₃.

Kernel sizes of the convolutional layers, the downscaling factors, and the first activation function and the activation functions B4 and C4 being the same activation function are only exemplary and the present embodiment is not limited to these particular configurations.

The convolutional stage S2 also includes a summation block similar to the summation block 302 and the summation block of the convolutional stage S2 is omitted in FIG. 3 because only the skip connections S13 and S23 that are relevant to a complete operation of the summation block 302 are illustrated. The convolutional stages S4 and S5 also include similar components as the convolutional stage S3. The skip connections for the convolutional stage S2, S4, or S5 are illustrated in FIG. 2, but are not described in detail because skip connections for the convolutional stage S2, S4, or S5 are similar to the skip connections S13 and S23 for the convolutional stage S3.

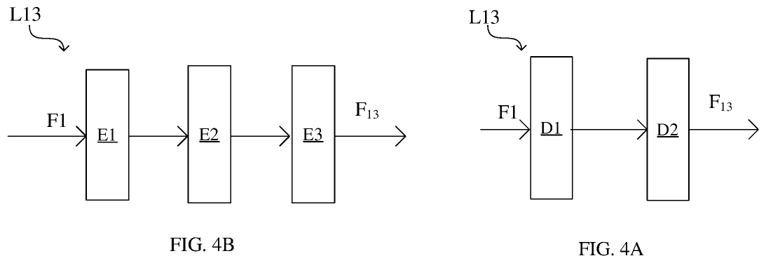

FIG. 4A is a diagram illustrating the downscaling stage L13 of the exemplary cross-stage skip connection S13 (shown in FIG. 3) in accordance with an embodiment of the present disclosure. The downscaling stage L13 includes a convolutional layer D1 without the first activation function and an activation function D2. The convolutional layer D1 receives the feature map F1, the convolutional layer D1 and the activation function D2 process layer-by-layer, and the activation function D2 outputs the feature map F₁₃. In an embodiment, the convolutional layer D1 is a 1×1 convolutional layer. In an embodiment, the convolutional layer D1 has a stride of 4 such that the convolutional layer D1 decreases, with the downscaling factor of 4, the scale of the feature map F1 to the scale of the feature map F₁₃. In an embodiment, the activation function D2 is a nonlinear activation function such as a Leaky ReLU operation.

FIG. 4B is a diagram illustrating the downscaling stage L13 of the exemplary cross-stage skip connection S13 (shown in FIG. 3) in accordance with another embodiment of the present disclosure. The downscaling stage L13 includes a pooling layer E1, a convolutional layer E2 without the first activation function, and an activation function E3. The pooling layer E1 receives the feature map F1, the pooling layer E1, the convolutional layer E2, and the activation function E3 process layer-by-layer, and the activation function E3 outputs the feature map F₁₃. In an embodiment, the pooling layer E1 decreases, with the downscaling factor of 4, the scale of the feature map F1 to the scale of the feature map F₁₃. In an embodiment, the pooling layer E1 is a max pooling layer. Alternatively, the pooling layer E1 is an average pooling layer. In an embodiment, the convolutional layer E2 is a 1×1 convolutional layer with a stride of 1. In an embodiment, the activation function E3 is a nonlinear activation function such as a Leaky ReLU operation.

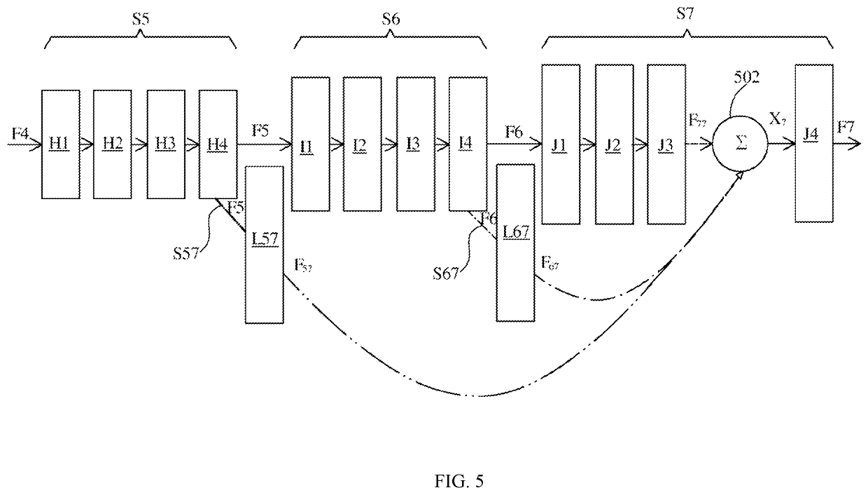

FIG. 5 is diagram illustrating cross-stage skip connections S57 and S67 for an exemplary convolutional stage S7 of the decoder 204 (shown in FIG. 2) in accordance with an embodiment of the present disclosure. The convolutional stage S5 includes a downscaling layer H1, a convolutional layer H2 with the first activation function, a convolutional layer H3 without the first activation function, and an activation function H4. The downscaling layer H1 receives the feature map F4, the downscaling layer H1, the convolutional layers H2 and H3, and the activation function H4 process layer-by-layer, and the activation function H4 outputs the feature map F5. The downscaling layer H1 downscales the feature map F4 with a downscaling factor such as 2. In an embodiment, the downscaling layer H1 is a pooling layer such as a max pooling layer or an average pooling layer. Other downscaling layers such as a convolutional layer with a stride of 2 are within the contemplated scope of the present disclosure. In an embodiment, the convolutional layers H2 and H3 are 3×3 convolutional layers. In an embodiment, the activation function H4 is a nonlinear activation function such as a Leaky ReLU operation.

The convolutional stage S6 includes an upscaling layer I1, a convolutional layer 12 with the first activation function, a convolutional layer 13 without the first activation function, and an activation function I4. The upscaling layer I1 receives the feature map F5, the upscaling layer I1, the convolutional layers 12 and 13, and the activation function I4 process layer-by-layer, and the activation function I4 outputs the feature map F6. The upscaling layer I1 upscales the feature map F5 with an upscaling factor such as 2. In an embodiment, the upscaling layer I1 is an upsampling layer that performs linear interpolation or bilinear interpolation. Other upscaling layers such as a deconvolutional layer with a stride of 2 are within the contemplated scope of the present disclosure. In an embodiment, the convolutional layers 12 and 13 are 3×3 convolutional layers. In an embodiment, the activation function I4 is a nonlinear activation function such as a Leaky ReLU operation.

The convolutional stage S7 includes an upscaling layer J1, a convolutional layer J2 with the first activation function, a convolutional layer J3 without the first activation function, a summation block 502, and an activation function J4. The upscaling layer J1 receives the feature map F6, the upscaling layer J1, the convolutional layers J2 and J3, and the activation function J4 process layer-by-layer, and the activation function J4 outputs the feature map F7. The upscaling layer J1 upscales the feature map F6 with an upscaling factor such as 2. In an embodiment, the upscaling layer J1 is an upsampling layer that performs linear interpolation or bilinear interpolation. Other upscaling layers such as a deconvolutional layer with a stride of 2 are within the contemplated scope of the present disclosure. In an embodiment, the convolutional layers J2 and J3 are 3×3 convolutional layers. In an embodiment, the activation function J4 is a nonlinear activation function such as a Leaky ReLU operation.

The skip connection S57 or S67 includes upscaling the feature map F5 or F6 of the feature maps F5 to F9 (shown in FIG. 2) by an upscaling stage L57 or L67, to generate a feature map F₅₇ or F₆₇, and adding the feature map F₅₇ or F₆₇ in addition by the summation block 502, to obtain a sum Xₙ of feature maps by following equation (2):

Xₙ=Σ_{m=b}^{m=n}Fₘₙ (2)

, where b is a stage number “5” of the last convolutional stage S5 of the encoder 202, m is a stage number “5” or “6” of a source stage S5 or S6 which is one of the last convolutional stage S5 the encoder 202 and the convolutional stages S6 to S9 of the decoder 204, n is a stage number “7” of a destination stage S7 of the convolutional stages S6 to S9, and when m<n, Fₘₙ is the feature map F₅₇ or F₆₇ obtained by the skip connection S57 or S67 between the source stage S5 or S6 with the stage number m and the destination stage S7 with the stage number n, and when m=n, Fₘₙ is a feature map F₇₇ obtained by the destination stage S7 with the stage number n. A scale and a number of channels of each of the feature maps F₅₇ and F₆₇, is same as a scale and a number of channels of the feature map F₇₇. In an embodiment, because the upscaling layer I1 and the upscaling layer J1 has the upscaling factor of 2, the upscaling stage L57 has an upscaling factor of 4, and the upscaling stage L67 has an upscaling factor of 2. Each summation operation (i.e. adding operation) in equation (2) is an element-wise summation operation.

In an embodiment, a number of channels of the feature map F₇₇ is set such that the feature map F₇₇ does not have information which is redundant with respect to the feature map F₅₇ or F₆₇. In this way, the convolutional stage S7 does not need to learn and generate information that has been learned and generated by the convolutional stages S5 and S6. The reuse of the feature map F₅₇ or F₆₇ instead of having redundant information respect to the feature map F₅₇ or F₆₇ in the feature map F₇₇ is represented by 3 dashed lines with different dashed line styles corresponding to the feature maps F₅₇, F₆₇, and F₇₇.

Kernel sizes of the convolutional layers, the downscaling factor, the upscaling factors, and the first activation function and the activation functions I4 and J4 being the same activation function are only exemplary and the present embodiment is not limited to these particular configurations.

The convolutional stage S6 also includes a summation block similar to the summation block 502 and the summation block of the convolutional stage S6 is omitted in FIG. 5 because only the skip connections S57 and S67 that are relevant to a complete operation of the summation block 502 are illustrated. The convolutional stages S8 and S9 also include similar components as the convolutional stage S7. The skip connections for the convolutional stage S6, S8, or S9 are illustrated in FIG. 2, but are not described in detail because skip connections for the convolutional stage S6, S8, or S9 are similar to the skip connections S57 and S67 for the convolutional stage S7.

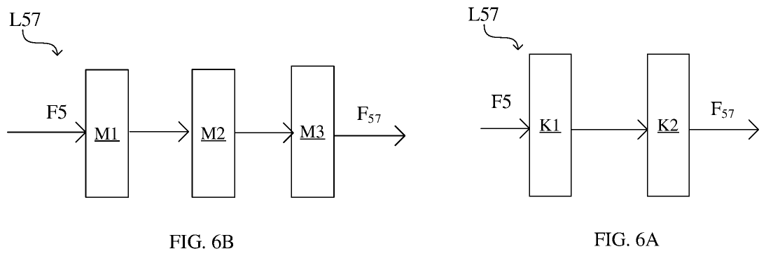

FIG. 6A is a diagram illustrating an upscaling stage L57 of an exemplary cross-stage skip connection S57 (shown in FIG. 5) in accordance with an embodiment of the present disclosure. The upscaling stage L57 includes a deconvolutional layer K1 without the first activation function and an activation function K2. The deconvolutional layer K1 receives the feature map F5, the deconvolutional layer K1 and the activation function K2 process layer-by-layer, and the activation function K2 outputs the feature map F₅₇. In an embodiment, the deconvolutional layer K1 is a 1×1 deconvolutional layer. In an embodiment, the deconvolutional layer K1 has a stride of 4 such that the deconvolutional layer K1 increases, with the upscaling factor of 4, the scale of the feature map F5 to the scale of the feature map F₅₇. In an embodiment, the activation function K2 is a nonlinear activation function such as a Leaky ReLU operation.

FIG. 6B is a diagram illustrating the upscaling stage L57 of the exemplary cross-stage skip connection S57 (shown in FIG. 5) in accordance with another embodiment of the present disclosure. The upscaling stage L57 includes an upsampling layer M1, a convolutional layer M2 without the first activation function, and an activation function M3. The upsampling layer M1 receives the feature map F5, the upsampling layer M1, the convolutional layer M2, and the activation function M3 process layer-by-layer, and the activation function M3 outputs the feature map F₅₇. In an embodiment, the upsampling layer M1 increases, with the upscaling factor of 4, the scale of the feature map F5 to the scale of the feature map F₅₇. In an embodiment, the upsampling layer M1 performs linear interpolation or bilinear interpolation. In an embodiment, the convolutional layer M2 is a 1×1 convolutional layer with a stride of 1. In an embodiment, the activation function M3 is a nonlinear activation function such as a Leaky ReLU operation.

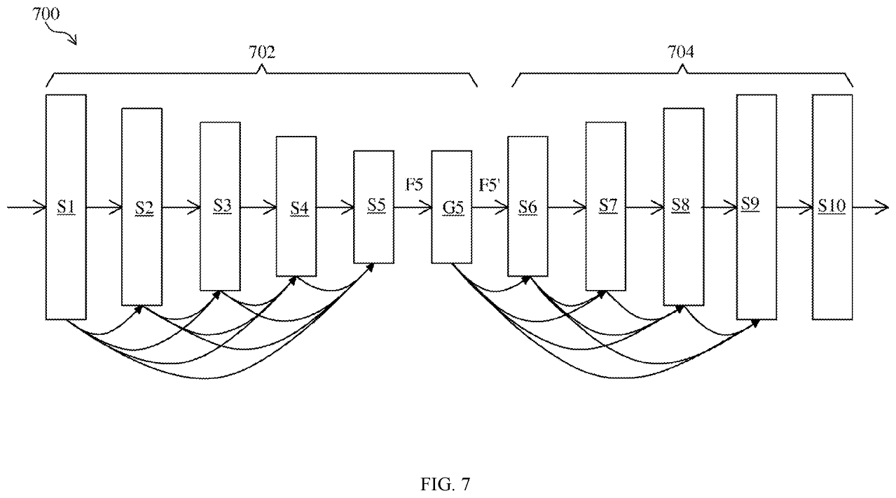

FIG. 7 is a diagram illustrating an encoder-decoder network 700 with cross-stage skip connections in accordance with another embodiment of the present disclosure. Compared to the encoder-decoder network 200 in FIG. 2, an encoder 702 of the encoder-decoder network 700 further includes a bottleneck stage G5. For the encoder-decoder network 200, the feature map output by the encoder 202 is the feature map F5, which is the last of the feature maps F1 to F5. For the encoder-decoder network 700, the bottleneck stage G5 receives the feature map F5, and outputs a feature map F5′. A feature map output by the encoder 702 is the feature map F5′. Because of such a difference, the convolutional stage S5 and the feature map F5 in the description for the decoder 204 of the encoder-decoder network 200 needs to be correspondingly changed to the bottleneck stage G5 and the feature map F5′ for a decoder 704 of the encoder-decoder network 700. The rest of description for the encoder-decoder network 200 can be applied mutatis mutandis to the encoder-decoder network 700. In an embodiment, the feature map F5′ has a same scale as the feature map F5.

In an embodiment, the bottleneck stage G5 includes a global pooling layer, and at least one convolutional layer with the first activation function. The global pooling layer receives the feature map F5, the global pooling layer and the at least one convolutional layer process layer-by-layer, and the at least one convolutional layer outputs the feature map F5′. In an embodiment, a number of layers of the at least one convolutional layer is 3. Each of the at least one convolutional layer is a 1×1 convolutional layer.

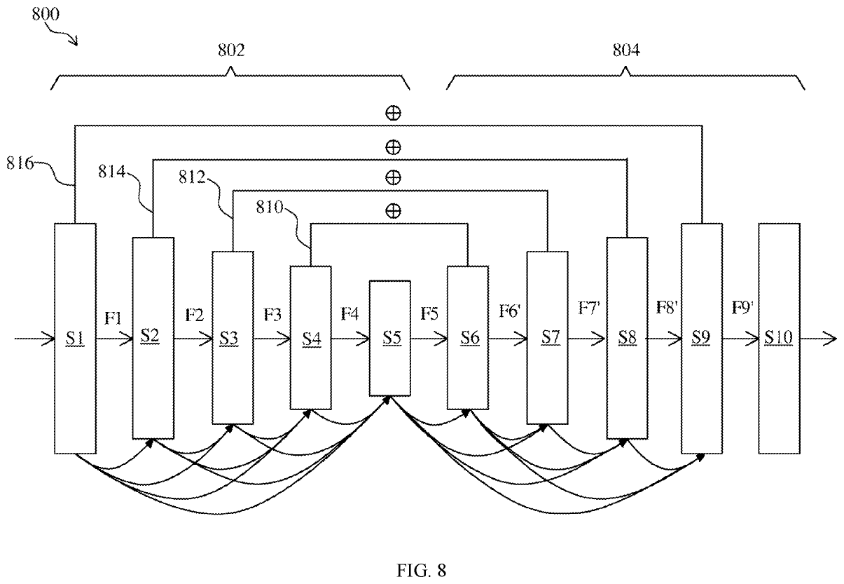

FIG. 8 is a diagram illustrating an encoder-decoder network 800 with cross-stage skip connections in accordance with still another embodiment of the present disclosure. Compared to the encoder-decoder network 200 in FIG. 2, the encoder-decoder network 800 further includes skip connections 810, 812, 814, and 816 that are across an encoder 802 and a decoder 804 of the encoder-decoder network 800. The skip connections 810, 812, 814, and 816 modify corresponding outputs of the convolutional stages S6 to S9, and therefore the feature maps F6 to F9 in the description for the decoder 204 need to be correspondingly changed to feature maps F6′ to F9′. The rest of description for the encoder-decoder network 200 can be applied mutatis mutandis to the encoder-decoder network 800.

In an embodiment, the feature map F4 output by the activation function of the convolutional stage S4 and a feature map output by the upscaling layer of the convolutional stage S6 have a substantially same scale. The skip connection 810 includes concatenating the feature map F4 and the feature map output by the upscaling layer of the convolutional stage S6. The feature map output by the upscaling layer of the convolutional stage S6 is input to layers of the convolutional stage S6 subsequent to the upscaling layer of the convolutional stage S6, to generate the feature map F6′ output by the convolutional stage S6. Similarly, the feature maps F3, F2, and F1 correspondingly output by the activation functions of the convolutional stages S3, S2, and S1 and feature maps correspondingly output by the upscaling layers of the convolutional stages S7, S8, and S9 have substantially same corresponding scales. The skip connections 812, 814, and 816 include correspondingly concatenating the feature maps F3, F2, and F1 and the feature maps output by the upscaling layers of the convolutional stages S7, S8, and S9. The feature maps output by the upscaling layers of the convolutional stage S7, S8, and S9 are correspondingly input to layers of the convolutional stages S7, S8, and S9 subsequent to the upscaling layers of the convolutional stages S7, S8, and S9, to correspondingly generate the feature map F7′, F8′, and F9′ correspondingly output by the convolutional stages S7, S8, and S9.

Furthermore, in an embodiment, during training, the input image 206 of the encoder-decoder network 200 is a short-exposure image captured under, for example, a low-light condition or an underwater condition. A loss function is calculated between the output image 208 of the encoder-decoder network 200 and a ground-truth image which is a corresponding long-exposure image. The loss function is a weighted joint loss of [symbol] ₁ and multi-scale structured similarity index (MS-SSIM), which is defined by equation (3):

[symbol]

=λ [symbol] +(1−λ) [symbol] ^{MS-SSIM} (3)

, where λ is set to 0.16 empirically, [symbol] is the [symbol] loss defined by equation (4), and [symbol] ^{MS-SSIM} represents MS-SSIM loss given by equation (5). Equation (4) is as follows:

$${ℒ}^{{ℓ}_{1}} = \frac{1}{N} {Σ}_{i ∈ I} \vert I ( i ) - \hat{I} ( i ) \vert \qquad ( 4 )$$

where Î and I are the output image 208 and the ground-truth image, respectively, and N is the total number of pixels in the input image 206. Equation (5) is as follows:

[symbol]

^{MS-SSIM}=1−MS−SSIM (5)

, where MS-SSIM for pixel i is defined by equations (6)-(8). Equations (6)-(8) are as follows:

$$\begin{matrix}MS - SSIM ( i ) = {l}_{M}^{α} ( i ) \cdot {\prod }_{j = 1}^{M} {cs}_{j}^{{β}_{j}} ( i ) & ( 6 ) \\ l ( i ) = \frac{2 {μ}_{x} {μ}_{y} + {C}_{1}}{{μ}_{x}^{2} + {μ}_{y}^{2} + {C}_{1}} & ( 7 ) \\ cs ( i ) = \frac{2 {σ}_{x y} + {C}_{2}}{{σ}_{x}^{2} + {σ}_{y}^{2} + {C}_{2}} , & ( 8 )\end{matrix}$$

where x and y represent two discrete non-negative signals that have been aligned with each other (e.g. two image patches extracted from a same spatial location from two images being compared, respectively); μₓ and μ_{y} are means, σₓ and σ_{y} are standard deviations, M is the number of levels, and α,β are the weights to adjust the contribution of each component. The means μₓ and μ_{y}, and the standard deviations σₓ and σ_{y} are calculated with a Gaussian filter, G₉, with zero mean and a standard deviation σ_{g}. Examples of MS-SSIM are described in more detail in “Multiscale structural similarity for image quality assessment,” Z. Wang, E. P. Simoncelli, A. C. Bovik, Conference on Signals, Systems and Computers, 2004.

Table 1, below, illustrates experimental results that may be achieved by the embodiments described with reference to FIGS. 1 to 6B, and FIG. 8. By employing the cross-stage skip connections for the convolutional stages outputting the feature maps with decreased scales, and the cross-stage skip connections for the convolutional stages outputting the feature maps with increased scales, information flow and gradient propagation may be improved, and therefore, performance such as a peak signal to noise ratio (PSNR) of the output image may be improved. By further setting the number of the channels of the feature map of each destination stage such that the feature map of each destination stage does not have information which is redundant with respect to the feature map(s) of the source stage(s) modified by the corresponding cross-stage skip connection(s), the feature map(s) of the source stage(s) modified by the corresponding cross-stage skip connection(s) are reused, and hence, a number of parameters of the encoder-decoder network may be reduced without sacrificing performance of the output image. Table 1 illustrates image denoising and enhancement for the embodiments described with reference to FIGS. 2 to 6B, and FIG. 8 as compared to an encoder-decoder network SID-net described by “Learning to see in the dark,” C. Chen, Q. Chen, J. Xu, V. Koltun, In CVPR, 2018. Both the embodiments described with reference to FIGS. 2 to 6B, and FIG. 8 and the encoder-decoder network SID-net may be run in the system described with reference to FIG. 1. As shown, compared to the encoder-decoder network SID-net, the embodiments described with reference to FIGS. 2 to 6B, and FIG. 8 may achieve substantially same PSNR with 45% reduction in a number of parameters.

TABLE 1
Results of Comparison on Image Denoising and Enhancement

| | | Number of |
|---|---|---|
| | PSNR | Parameters |
| SID-net | 28.6 | 7.76M |
| embodiments described with reference to | 28.5 | 4.24M |
| FIGS. 2 to 6B, and FIG. 8 | | |

Some embodiments have one or a combination of the following features and/or advantages. In an embodiment, an encoder of an encoder-decoder network includes a plurality of first convolutional stages. For each second convolutional stage of the first convolutional stages, a first skip connection is added between each second convolutional stage and each of at least one remaining convolutional stage of the first convolutional stages corresponding to each second convolutional stage. In an embodiment, a decoder of the encoder-decoder network includes a plurality of third convolutional stages. For each fourth convolutional stage of the last convolutional stage of the encoder and the third convolutional stages, a second skip connection is added between each fourth convolutional stage and each of at least one remaining convolutional stage of the third convolutional stages corresponding to each fourth convolutional stage. Because information flow and gradient propagation of the encoder-decoder network may be improved by the first skip connection and the second skip connection, performance such as PSNR of an output image of the encoder-decoder network may be improved. In an embodiment, each of the first skip connection and the second skip connection is between a destination stage and a source stage. A number of the channels of a feature map of the destination stage is set such that the feature map of the destination stage does not have information which is redundant with respect to the feature map of the source stage modified by the first skip connection or the second skip connection. Because the feature map of the source stage modified by the first skip connection or the second skip connection is reused, a number of parameters of the encoder-decoder network may be reduced without sacrificing performance of the output image.

A person having ordinary skill in the art understands that each of the units, modules, layers, blocks, algorithm, and steps of the system or the computer-implemented method described and disclosed in the embodiments of the present disclosure are realized using hardware, firmware, software, or a combination thereof. Whether the functions run in hardware, firmware, or software depends on the condition of application and design requirement for a technical plan. A person having ordinary skill in the art can use different ways to realize the function for each specific application while such realizations should not go beyond the scope of the present disclosure.

It is understood that the disclosed system, and computer-implemented method in the embodiments of the present disclosure can be realized with other ways. The above-mentioned embodiments are exemplary only. The division of the modules is merely based on logical functions while other divisions exist in realization. The modules may or may not be physical modules. It is possible that a plurality of modules are combined or integrated into one physical module. It is also possible that any of the modules is divided into a plurality of physical modules. It is also possible that some characteristics are omitted or skipped. On the other hand, the displayed or discussed mutual coupling, direct coupling, or communicative coupling operate through some ports, devices, or modules whether indirectly or communicatively by ways of electrical, mechanical, or other kinds of forms.

The modules as separating components for explanation are or are not physically separated. The modules are located in one place or distributed on a plurality of network modules. Some or all of the modules are used according to the purposes of the embodiments.

If the software function module is realized and used and sold as a product, it can be stored in a computer readable storage medium. Based on this understanding, the technical plan proposed by the present disclosure can be essentially or partially realized as the form of a software product. Or, one part of the technical plan beneficial to the conventional technology can be realized as the form of a software product. The software product is stored in a computer readable storage medium, including a plurality of commands for at least one processor of a system to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program instructions.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A computer-implemented method, comprising:
receiving and processing a first image, and outputting a first feature map by an encoder, wherein the encoder comprises:
a plurality of first convolutional stages that receive the first image and output stage-by-stage a plurality of second feature maps corresponding to the first convolutional stages;
wherein
the second feature maps have gradually decreased scales; and
for each second convolutional stage of the first convolutional stages, a first skip connection is added between each second convolutional stage and each of at least one remaining convolutional stage of the first convolutional stages corresponding to each second convolutional stage.

2. The method of claim 1, wherein
the first skip connection comprises downscaling one of the second feature maps, to generate a third feature map, and adding the third feature map in addition, to obtain a sum Xⱼ of fourth feature maps by following an equation:
Xⱼ=Σᵢ₌ₐ^{i=j}Fᵢⱼ
where a is a stage number of the first of the first convolutional stages, i is a stage number of a first source stage in the first convolutional stages, j is a stage number of a first destination stage of the first convolutional stages, and when i<j, Fᵢⱼ is the third feature map obtained by the first skip connection between the first source stage with the stage number i, and the first destination stage with the stage number j, and when i=j, Fᵢⱼ is a fifth feature map obtained by the first destination stage with the stage number j; and
a scale of the third feature map is same as a scale of the fifth feature map.

3. The method of claim 2, wherein downscaling is performed by a first downscaling stage comprising a first activation function that outputs the third feature map; the first destination stage with the stage number j comprises a first convolutional layer and a second activation function;
the first convolutional layer outputs the fifth feature map, and the second activation function receives the sum of the fourth feature maps and outputs a sixth feature map of the second feature maps.

4. The method of claim 3, wherein the first downscaling stage further comprises a second convolutional layer preceding the first activation function and having a first stride such that the second convolutional layer decreases the scale of the one of the second feature maps to the scale of the third feature map.

5. The method of claim 4, wherein the second convolutional layer is a 1×1 convolutional layer.

6. The method of claim 3, wherein the first downscaling stage further comprises a first pooling layer that decreases the scale of the one of the second feature maps to the scale of the third feature map, and a third convolutional layer following the first pooling layer and having a stride of 1.

7. The method of claim 6, wherein the third convolutional layer is a 1×1 convolutional layer.

8. The method of claim 2, wherein a number of channels of the fifth feature map is set such that the fifth feature map does not have information which is redundant with respect to the third feature map.

9. The method of claim 1, wherein the last of the second feature maps is the first feature map.

10. The method of claim 1, wherein the encoder further comprises:
a bottleneck stage that receives the last of the second feature maps and outputs the first feature map, wherein the bottleneck stage comprises a global pooling layer.

11. The method of claim 1, further comprising:
receiving and processing the first feature map, and outputting a second image by a decoder, wherein the decoder comprises;
a plurality of third convolutional stages that receive the first feature map and output stage-by-stage a plurality of seventh feature maps corresponding to the third convolutional stages;
wherein
the first feature map and the seventh feature maps have gradually increased scales;
for each fourth convolutional stage of the last convolutional stage of the encoder and the third convolutional stages, a second skip connection is added between each fourth convolutional stage and each of at least one remaining convolutional stage of the third convolutional stages corresponding to each fourth convolutional stage;
the last convolutional stage of the encoder outputs the first feature map; and
each fourth convolutional stage outputs a corresponding eighth feature map of which a scale is increased in a corresponding fifth convolutional stage of the third convolutional stages, wherein the corresponding fifth convolutional stage is immediately subsequent to each fourth convolutional stage.

12. The method of claim 11, wherein
the second skip connection comprises upscaling one of the first feature map and the seventh feature maps, to generate a ninth feature map, and adding the ninth feature map in addition, to obtain a sum Xₙ of tenth feature maps by following an equation:
Xₙ=Σ_{m=b}^{m=n}Fₘₙ
, where b is a stage number of the last convolutional stage of the encoder, m is a stage number of a second source stage which is one of the last convolutional stage of the encoder and the third convolutional stages, n is a stage number of a second destination stage of the third convolutional stages, and when m<n, Fₘₙ is the ninth feature map obtained by the second skip connection between the second source stage with the stage number m and the second destination stage with the stage number n, and when m=n, Fₘₙ is an eleventh feature map obtained by the second destination stage with the stage number n; and
a scale of the ninth feature map is same as a scale of the eleventh feature map.

13. The method of claim 12, wherein upscaling is performed by a first upscaling stage comprising a third activation function that outputs the ninth feature map; the second destination stage with the stage number n comprises a fourth convolutional layer and a fourth activation function; the fourth convolutional layer outputs the eleventh feature map, and the fourth activation function receives the sum of the tenth feature maps and outputs a twelfth feature map of the seventh feature maps.

14. The method of claim 13, wherein the first upscaling stage further comprises a first deconvolutional layer preceding the third activation function and having a second stride such that the first deconvolutional layer increases the scale of the one of the first feature map and the seventh feature maps to the scale of the ninth feature map.

15. The method of claim 14, wherein the first deconvolutional layer is a 1×1 deconvolutional layer.

16. The method of claim 13, wherein the first upscaling stage further comprises a first upsampling layer that increases the scale of the one of the first feature map and the seventh feature maps to the scale of the ninth feature map, and a fifth convolutional layer following the first upsampling layer and having a stride of 1.

17. The method of claim 16, wherein the fifth convolutional layer is a lx1 convolutional layer.

18. The method of claim 12, wherein a number of channels of the eleventh feature map is set such that the eleventh feature map does not have information which is redundant with respect to the ninth feature map.

19. A system, comprising:
at least one memory configured to store program instructions; and
at least one processor configured to execute the program instructions, which cause the at least one processor to perform steps comprising:
receiving and processing a first image, and outputting a first feature map by an encoder, wherein the encoder comprises:
a plurality of first convolutional stages that receive the first image and output stage-by-stage a plurality of second feature maps corresponding to the first convolutional stages;
wherein
the second feature maps have gradually decreased scales; and
for each second convolutional stage of the first convolutional stages, a first skip connection is added between each second convolutional stage and each of at least one remaining convolutional stage of the first convolutional stages corresponding to each second convolutional stage.

20. A system, comprising:
at least one memory configured to store program instructions; and
at least one processor configured to execute the program instructions, which cause the at least one processor to perform steps comprising:
receiving and processing a first feature map, and outputting a first image by a decoder, wherein the first feature map is output by an encoder, and the decoder comprises:
a plurality of first convolutional stages that receive the first feature map and output stage-by-stage a plurality of second feature maps corresponding to the first convolutional stages;
wherein
the first feature map and the second feature maps have gradually increased scales;
for each second convolutional stage of the last convolutional stage of the encoder and the first convolutional stages, a first skip connection is added between each second convolutional stage and each of at least one remaining convolutional stage of the first convolutional stages corresponding to each second convolutional stage;
the last convolutional stage of the encoder outputs the first feature map; and
each second convolutional stage outputs a corresponding third feature map of which a scale is increased in a corresponding third convolutional stage of the first convolutional stages, wherein the corresponding third convolutional stage is immediately subsequent to each second convolutional stage.
